(19) United States
(12) Patent Application Publication
(10) Pub. No.: US 2008/0122934 A1
(43) Pub. Date: May 29, 2008

(54) Audio/video messaging device and system

(76) Inventor: Martin J. Marotti, Carmel, IN (US)

Correspondence Address: BOWMAN & ASSOCIATES, 1016 3rd Avenue, SW, Suite #106, CARMEL, IN, 46032, US

(21) Appl. No.: 11/880,563

(22) Filed: Jul. 23, 2007

Related U.S. Application Data
(60) Provisional application No. 60/861,133, filed on Nov. 27, 2006.

(51) Int. Cl. H04N 5/225

(52) U.S. Cl. 348/207.1; 348/E05.007

(57) ABSTRACT

An audio/video messaging device allows a user to record, store and replay short audio/video messages. Key components of the present audio/video messaging device include a camera to capture video, a microphone to capture audio, memory, such as but not limited to flash memory, or a hard drive for storing the captured audio and video, a display to replay the video, a speaker to replay the audio, and controls to manage the recording and playback of audio/video messages. The present audio/video messaging device allows creation of a predetermined number of audio/video messages corresponding to a predetermined number of message slots. Each audio/video message may last up to a predetermined length of time and are sequentially stored in the memory/hard drive corresponding to the message slots. The controls allow navigation between audio/video message slots for creation, replay and erasure of an audio/video message. A remote control may also be provided to perform the various commands/features/functions of the audio/video messaging device. The present audio/video messaging device provides a level of information and/or communication that conveys the full range of emotional content not available in written, voice or still picture messages.

### CROSS-REFERENCE TO RELATED APPLICATIONS

This patent application claims the benefit of and/or priority to U.S. provisional patent application Ser. No. 60/861,133 filed Nov. 27, 2006, entitled “Video Messaging System”, the entire contents of which is specifically incorporated herein by reference.

### BACKGROUND OF THE INVENTION

1. Field of the Invention

The present invention relates to message creation and delivery devices or messaging devices and, more particularly, to audio and visual messaging devices for creating and posting audio and visual messages.

2. Background Information

The need to communicate with others regarding various matters is vital. This is especially true in families, between co-workers, friends, members, associates and others too numerous to list. Because individuals oftentimes have busy and varying schedules, it is typically not possible to have a personal communication with someone. Because of this, a variety of message devices have been devised that allows one to post a written message. Examples of such message posting devices include cork boards, bulletin boards, dry erase boards and the like. These devices, however, only allow the user to communicate via written means. As such, it may be difficult to adequately convey a message by use of written expression only, which is a passive means of communication.

In view of the shortcomings of written messages, various devices have been made that allow a user to record an audio message. For instance, telephone answering machines typically now allow a user to record an audio message directly onto the telephone answering machine instead of just receiving and recording telephone messages. Some devices do more than just record an audio message. In U.S. Pat. No. 6,690,912 issued Feb. 10, 2004 to Vaughn, there is disclosed an audio and visual message center that provides a plurality of communication devices. Particularly, the Vaughn device provides one or more visual communication devices such as an erasable board, a calendar, a pressure sensitive adhesive surface area, a cork board, a felt pad, a clip board, a note pad or metal surface and an audio message communication device that allows the recording and playback of an audio message. The Vaughn device thus allows a user to provide an audio message in addition to a written message and/or the posting of a message. While the Vaughn device is effective in allowing the user to provide an audio message in addition to posting a written or other message, its interactive effects are poor and impersonal.

In addressing the shortcomings of the prior art such as Vaughn, U.S. Patent Publication 2005/0055797 by Yeh published Mar. 16, 2006, provides an interactive message device that incorporates a photographic device with an audio message recorder. The photographic device allows a user to take a photograph that is displayed on the message device along with the audio message. This provides a more personal message than a written message alone, but does little to further the meaning and/or understanding of the communication.

It is therefore evident from the above that there is a need for a message or messaging device that provides a more personal level of communication.

It is also evident from the above that there is a need for a message or messaging device that provides a greater level of communication to a recipient of the message.

The above needs and others are satisfied by the present invention.

### SUMMARY OF THE INVENTION

The present invention is an audio and video (audio/video) messaging device that records and plays audio/video messages. The audio/video messaging device provides discrete audio/video message slots for recording, playing, storing and erasing audio/video messages all under the control of a user interface.

Key components of the present audio/video messaging device include a camera to capture video, a microphone to capture audio, memory such as but not limited to flash memory or a hard drive for storing the captured audio and video, a display to replay the video, a speaker to replay the audio, and controls to manage the recording and playback of audio/video messages.

Each audio/video message may last up to a predetermined length of time and are sequentially stored in the memory/hard drive corresponding to the message slots. The controls allow navigation between audio/video message slots for creation, replay and erasure of an audio/video message.

In one form, the audio/video messaging device includes one or more communication ports that allow connection to one or more communication channels. This allows the present audio/video messaging device to send and/or receive audio/video messages to and/or from another audio/video messaging device and/or computer.

The present invention will be more apparent upon reading the following detailed description in conjunction with the accompanying drawings.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram representation of an audio/video messaging device forming the present invention;

FIG. 2 is a front view of an embodiment of the audio/video messaging device of FIG. 1 fashioned in accordance with the present principles;

FIG. 3 is a right side view of the audio/video messaging device of FIG. 2 taken along line 3-3 thereof;

FIG. 4 is a left side view of the audio/video messaging device of FIG. 2 taken along line 4-4 thereof;

FIG. 5 is a rear or back view of the audio/video messaging device of FIG. 2;

FIG. 6 is an enlarged view of the controls of the audio/video messaging device of FIG. 2;

FIG. 7 is a front view of another embodiment of the audio/video messaging device of FIG. 1 fashioned in accordance with the present principles;

FIG. 8 is a top view of the audio/video messaging device of FIG. 7 taken along line 8-8 thereof;

FIG. 9 is a right side view of the audio/video messaging device of FIG. 7 taken along line 9-9 thereof;

FIG. 10 is a rear or back view of the audio/video messaging device of FIG. 7;

FIG. 11 is an enlarged view of a portion of the rear of the audio/video messaging device of FIG. 7 taken along circle 11-11 of FIG. 9;

FIG. 12 is a front view of the audio/video messaging device of FIG. 7 with a screen orientation swivel and shown with the screen in a landscape view as compared with a portrait view as in FIG. 7;

FIG. 13 is a block diagram of the present audio/video messaging device;

FIG. 14 is a diagram illustrating connection and/or communication options between two of the present audio/video messaging devices; and

FIG. 15 is an illustration of use of the present audio/video messaging device both as a stand-alone unit and as incorporated into a consumer device.

Like reference numerals indicate the same or similar parts throughout the several figures.

An overview of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF THE PREFERRED EMBODIMENT

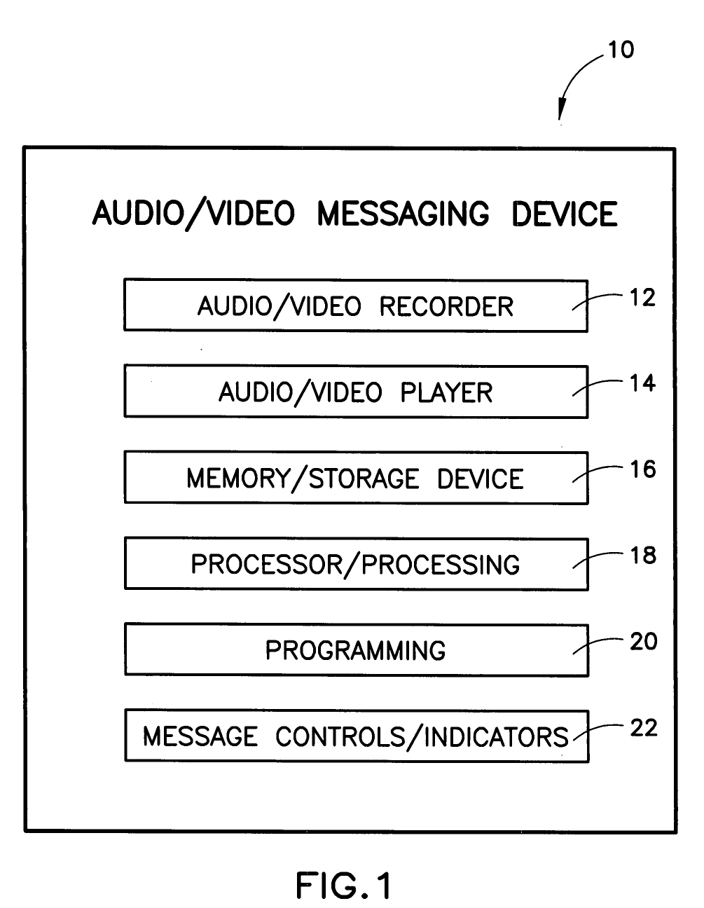

Referring to FIG. 1, there is shown a block diagram of an audio and video (audio/video or A/V) messaging device 10 in its simplest form according to the principles of the present invention. The A/V messaging device 10 is configured, adapted and/or operable to record, store and play the recorded audio/video messages. In one form, the audio/video messaging device 10 is also configured, adapted and/or operable to receive pre-recorded audio/video messages for storage and playback. The received audio/video messages may be made by another audio/video device 10 or may be made via a computer, camcorder or other audio/video device. In one form, the audio/video messaging device 10 is also configured, adapted and/or operable to record and send the recorded audio/video messages to one or more other audio/video messaging devices 10 for storage and playback.

In its simplest form, the messaging device 10 has a processor/processing circuitry 18, an audio/video recorder 12, an audio/video player 14, memory/storage device 16, message controls/indicators 22 and programming 20. The audio/video recorder 12 is configured, adapted and/or operable to receive and record audio and video messages. The audio/video player 14 is configured, adapted and/or operable to play the recorded (stored) audio and video messages. The memory/storage device 16 is operable to digitally store the recorded audio/video messages. The processor/processing circuitry 18 is configured, adapted and/or operable to control the audio/video messaging device 10 under direction of the programming 20. The message controls/indicators 22 provide a user interface that allows the user to control the audio/video messaging device 10. Particularly, the user interface allows the user to determine if an audio/video message has been recorded, record an audio/video message, play (view and hear) a recorded audio/video message, and delete a recorded audio/video message.

The audio/video messaging device 10 is preferably, but not necessarily, a stand-alone electronic device. However, as explained herein, the audio/video messaging device 10 may be incorporated into other devices such as appliances, structures, electronic devices and/or the like (see e.g. FIG. 15). As such, the present audio/video messaging device 10 may be embodied in various ways.

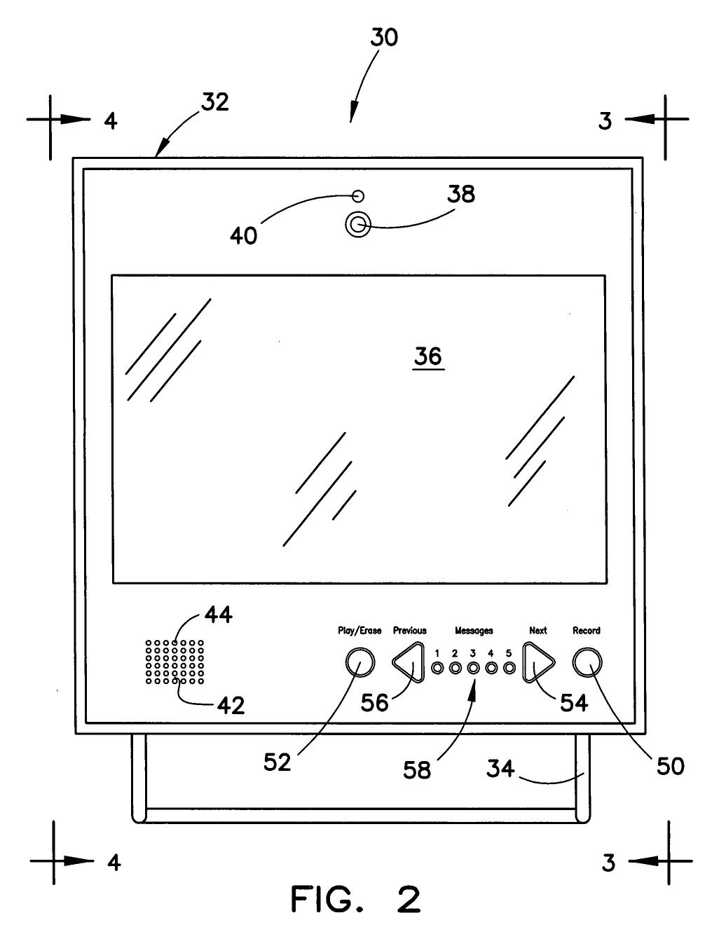

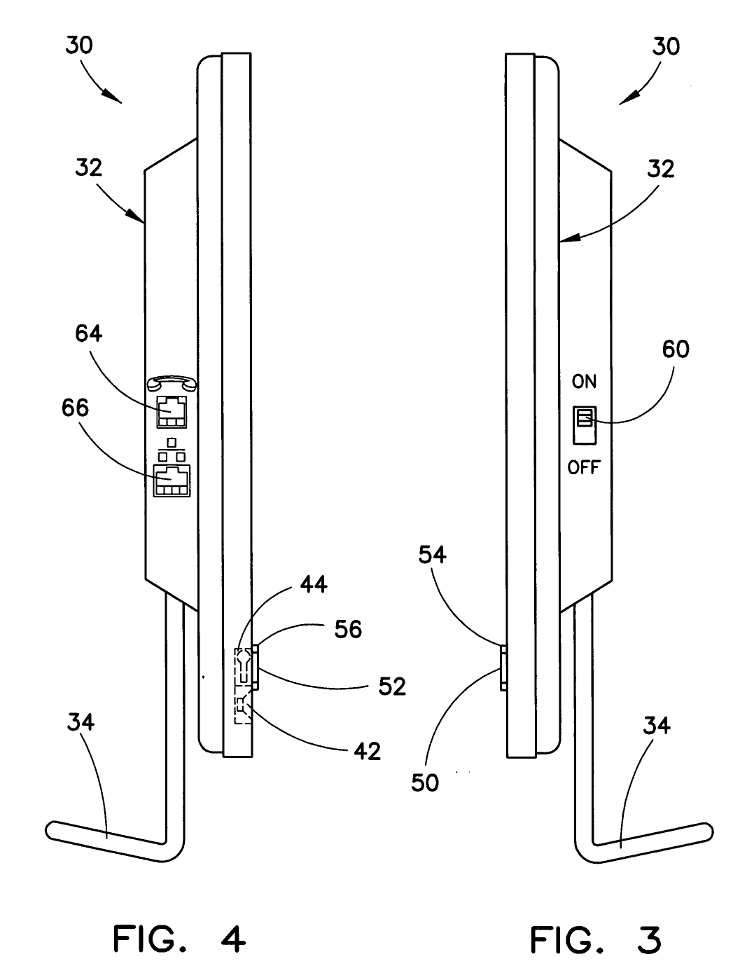

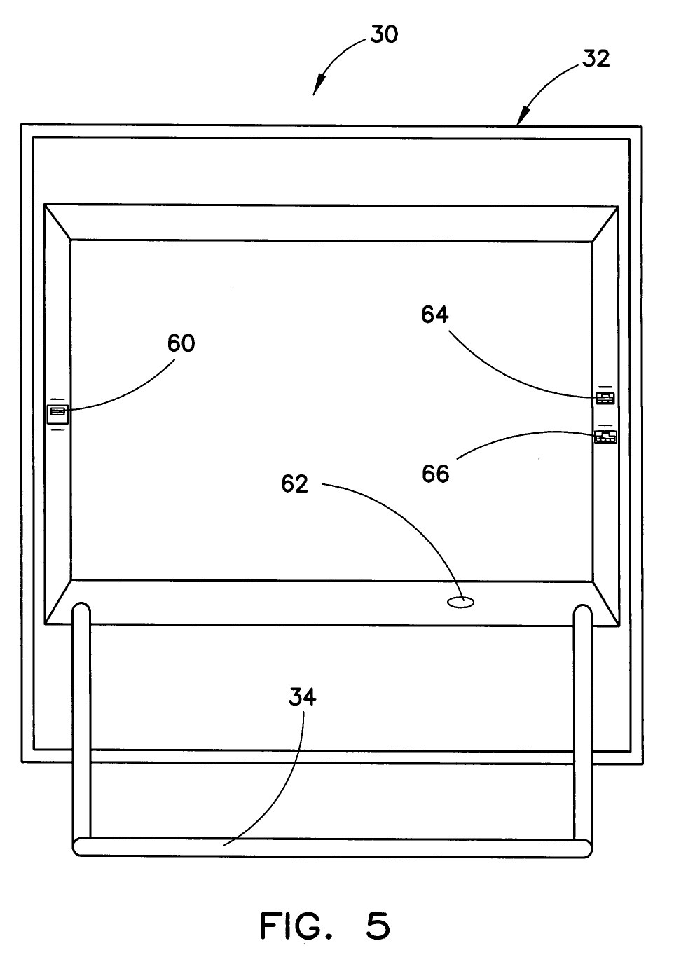

Referring now to FIGS. 2-5, there is depicted an exemplary embodiment of the present audio/video messaging device generally designated 30. The audio/video messaging device 30 has a housing 32 that is supported on a stand 34. The housing 32 is preferably formed of plastic but may, however, be formed by other materials. The stand 34 is optional as the housing 32 may be mounted or hung directly onto a wall, door, appliance or the like. As best seen in FIGS. 3 and 4, the stand 34 is configured such that the audio/video messaging device 30 tilts slightly backward. Of course, the housing 32 may be supported on other types and/or configurations of stands.

The audio/video messaging device 30 has a color video display or screen 36 that is situated in the housing 32 and is configured, adapted and/or operable to show, display or play video. The video is the video portion of an audio/video message as well as live video from a video camera 38 such as during recording of an audio/video message. The display 36 may be any type of display but is preferably a flat panel type of display such as an LCD, a TFT type display or other type of display. In order to receive video for recording and/or storage in memory (e.g. flash memory) or in a storage device (e.g. hard drive) of the present audio/video messaging device 30, the housing 32 holds the video camera 38. The video camera 38 is preferably, but not necessarily, a digital video camera such as those used in web cams, digital video recorders (“camcorders”) and/or the like, but may be any type of video camera. An LED 40 is situated proximate the video camera 38 and is operable to indicate to the user that the video camera 38 is on and thus the recording of video is about to occur and/or is occurring. The LED 40 is also operable to indicate that the video camera 38 is off. The video is digitized and stored in the memory, storage device and/or other digital storage device.

In order to receive audio for recording and/or storage in the memory or storage device of the present audio/video messaging device 30, the housing 32 supports a microphone or other type of audio pickup or reception device 44. The microphone 44 is preferably, but not necessarily, situated behind a plurality of holes in the front side of the housing 32. The microphone 44 is operable to receive audio from the user. The LED 40 is operable to indicate to the user that the microphone 44 is on and thus the recording of audio is about to occur and/or is occurring. The LED 40 is also operable to indicate that the microphone 40 is off. The received audio is digitized and stored in the memory, hard drive or other digital storage device of the audio/video message device 30. A speaker 42 is situated in the housing behind the plurality of holes in the front side of the housing 32. The speaker 42 is operable to play back the recorded audio.

Since the audio/video messaging device 30 is electronic, it must use electricity. As such, the audio/video messaging device 30 uses batteries or is connectable to a source of alternating current (A/C) electricity (e.g. a household A/C outlet) either through an appropriate power supply that resides external to the housing 32 (with a power cord) or is internal thereto. A power jack 62 is provided for receipt of a power cord. Optionally, the audio/video messaging device 30 may include battery back-up. An on/off switch 60 is provided in order to turn the audio/video messaging device 30 on and off. It is not necessary to turn the audio/video messaging device 30 on and off between uses as it goes into and remains in a low power consumption (i.e. standby mode) when not in use.

The user interface or message controls/indicators of the present audio/video messaging device 30 is situated on the front of the housing 32 and includes a Record button or key 50, a Play/Erase button or key 52, a Next or right advance button or key 54, a Previous or left advance button or key 56 and a plurality of LEDs 58. The Record key 50 is operable to begin recording an audio/video message. The Play/Erase key 52 is operable to play an audio/video message and to erase an audio/video message. The LEDs 58 each represent individual message “slots” or discrete number of audio/video messages that can be recorded and/or played. It should be appreciated that while five (5) LEDs 58 are shown, and thus the audio/video messaging device 30 can accommodate five (5) audio/video messages, the number of LEDs and thus number of audio/video slots may vary as desired. Additionally, while not shown, the individual LEDs 58 representing the number of audio/video message slots may be replaced by other indicators or a single indicator as desired.

The audio/video messaging device 30 provides a discrete number of audio/video message “slots” for recording audio/video messages and which indicate whether a message slot is empty and thus ready for recording an audio/video message, whether a message slot has a recorded message, and whether a message slot that has a recorded audio/video message has been played or viewed and heard. These message slots are provided for in the memory of the present audio/video messaging device and are represented by the indicators or LEDs of the user interface or control area thereof.

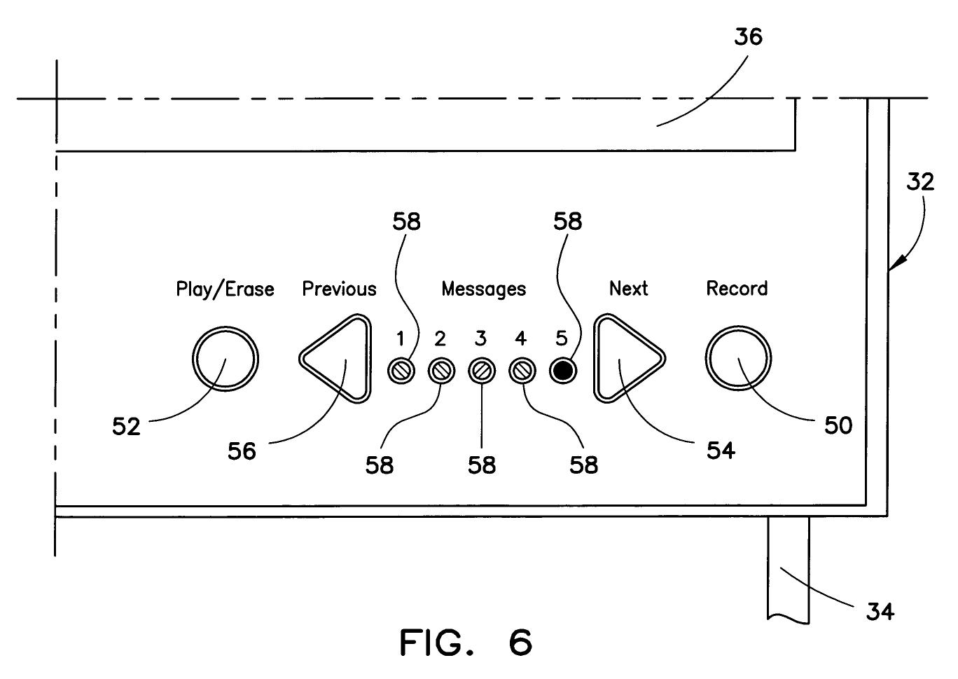

The Next and Previous keys 54 and 56 are operable to advance or move back and forth between each memory or audio/video message slot. In this manner, the user may cycle through the message slots in order to move to a particular audio/video message slot. A message slot may be unused or open (i.e. no message exists for or is associated with the particular message slot) and ready for recording of an audio/video message. This is represented by having the associated LED 58 off. Referring to FIG. 6, such is represented by message slot labeled “5.” A message slot may be occupied or contain or be associated with an audio/video message. The occupied message slot may contain an audio/video message that either has or has not been played. When the message slot has an audio/video message that has not been played, the associated LED 58 will be on and flashing. When the audio/video message has been played, the LED 58 will be on but not flash and be a solid color. An on LED 58 (whether flashing or solid) is of a particular color such as green. In FIG. 6 occupied message slots labeled “1”, “2” and “4” contain audio/video messages and would be flashing if not previously played or solid if previously played. As the user cycles through the message slots, the associated LED 58 is highlighted (i.e. solid on) by use of a second particular color such as yellow. In FIG. 6, the message slot labeled “3” represents a message slot that has currently been selected. Such selection may be for playing an audio/video message that resides at that particular message slot or may be for recording an audio/video message where no audio/video message resides at the particular message slot. It should be appreciated that other schemes may be used to indicate whether an audio/video message slot is open (empty or unoccupied) or contains an audio/video message and whether it has or has not been played.

When a highlighted message slot is occupied, pressing the Play/Erase key 52 will play the audio/video message. Preferably, but not necessarily, the display 36 will automatically turn off and the audio/video messaging device 30 will go into a standby mode after the playing of the audio/video messaging device 30 and/or within a predetermined period of time of non-use. The audio/video messaging device 30 does not have to be physically turned off between uses, as it will remain in a low power consumption state (i.e. standby mode) until the next operator activity. Holding down the Play/Erase key 52 for a predetermined amount of time (e.g. 5 seconds) will erase the audio/video message from the particular message slot. All audio/video messages will remain in memory until they are erased, even if the audio/video messaging device 30 is turned off or unplugged. After an audio/video message has been erased, the particular message slot is ready to record another audio/video message.

Recording of an audio/video message is initiated by selecting an open message slot utilizing the Next and/or Previous message slot navigation keys 54 and 56. Pressing the Record key 50 will turn on the display 36 and show a live image from the camera 38. The LED 40 indicator will flash for a predetermined period of time (e.g. 5 seconds) giving the user time to position himself/herself as appropriate. The LED 40 will turn to a solid color (e.g. green) and the camera 38 and the microphone 44 being recording an audio/video message. Preferably, but not necessarily, a predetermined amount of time (e.g. 60 seconds) is provided per audio/video message. When the predetermined amount of recording time has expired, the recording stops and the audio/video message is stored in the memory, hard drive or other digital storage media/device. Pressing the Record key 50 before the predetermined amount of record time has expired will stop recording at that point. The audio/video message will then be stored in the memory, hard drive or other digital storage media/device.

In another manner or in addition to the above, when initiating a recording, the color display 36 may show a black and white image while the LED 40 is flashing during the positioning period or instead of the flashing LED 40 to provide a more distinct indication of the positioning period. After the predetermined positioning period of time, the display 36 goes to color indicating that recording is taking place.

The audio/video messaging device 30 also includes a telephone jack 64 for connection to a telephone line. This allows the audio/video messaging device 30 to communicate via services offered through a telephone line such as is described below. Moreover, the audio/video messaging device 30 includes an Ethernet jack 66 for connection to an Ethernet port. This allows the audio/video messaging device 30 to communicate via Ethernet such as is described below. In brief, such communication involves sending and/or receiving audio/video messages to and/or from another audio/video messaging device.

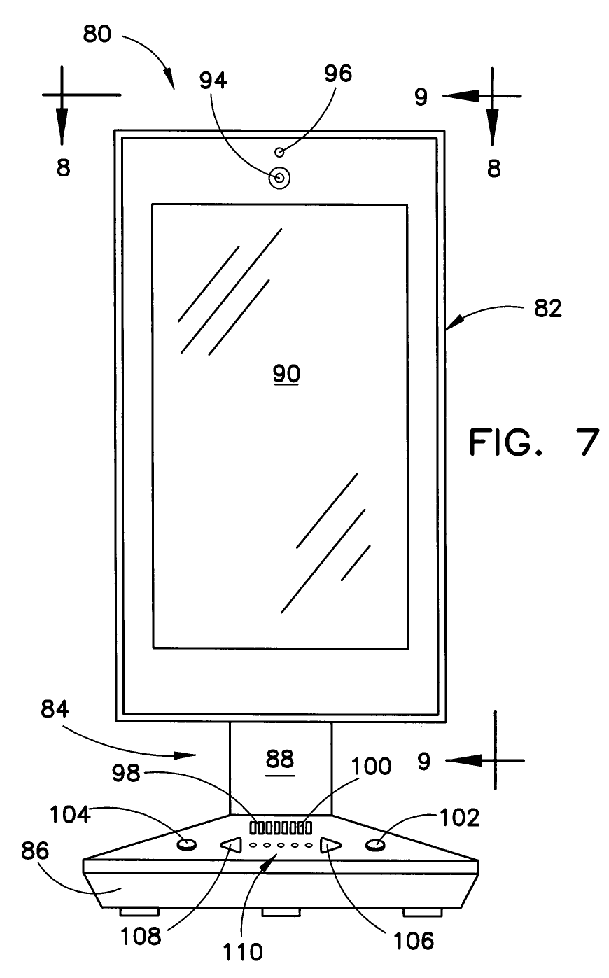

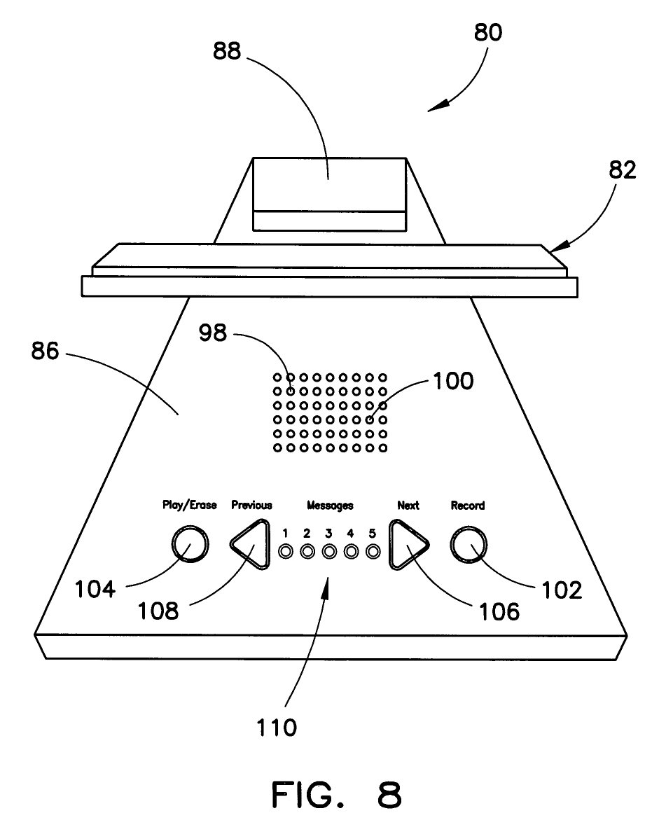

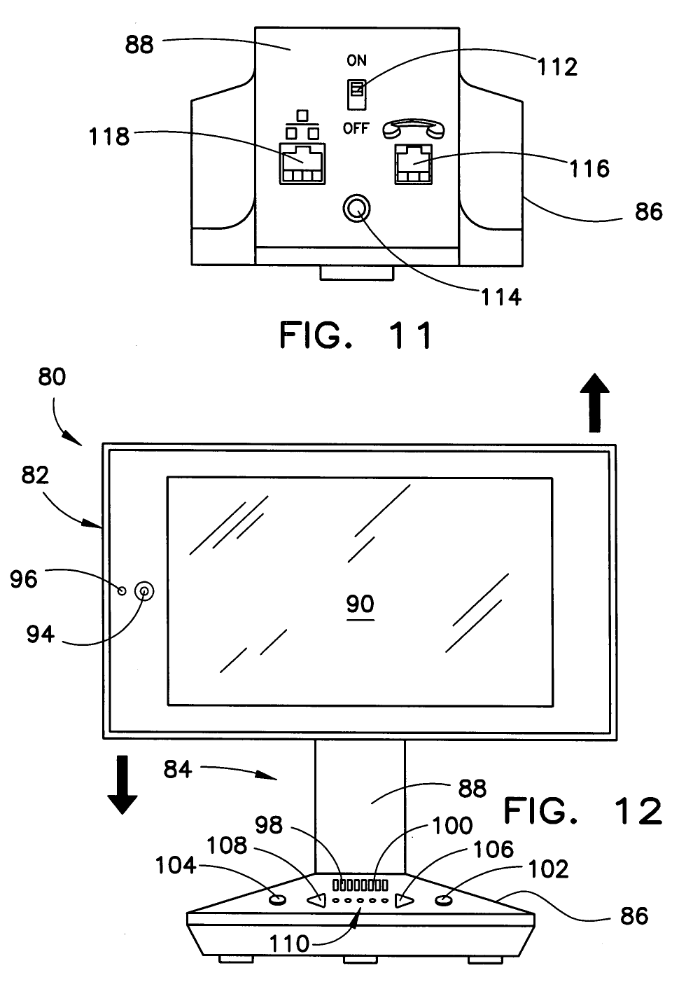

Referring now to FIGS. 7-12, there is shown another embodiment of an audio/video messaging device generally designated 80 fashioned in accordance with the present principles. The audio/video messaging device 80 has a panel or housing 82 that is supported on and/or by a stand 84. The housing 82 and stand 84 are preferably formed of plastic but may, however, be formed by other materials. The stand 84 has a base 86 and an upright or arm 88 that extends from the base 86. The housing supports a color video display or screen 90 that is configured, adapted and/or operable to show, display or play video. The video is the video portion of an audio/video message as well as live video imaged from a video camera 94, likewise supported in the housing 82. The video camera 94 receives video for recording and/or storage in memory (e.g. flash memory) or in a storage device (e.g. hard drive) of the present audio/video messaging device 80. The display 90 may be any type of display but is preferably a flat panel type of display such as an LCD, a TFT type display or other type of display.

The video camera 94 is preferably, but not necessarily, a digital video camera such as those used in web cams, digital video recorders (“camcorders”) and/or the like, but may be any type of video camera. An LED or indicator 96 is situated proximate the video camera 94 and is operable to indicate to the user that the video camera 94 is on and thus the recording of video is about to occur and/or is occurring. The LED 96 is also operable to indicate that the video camera 94 is off. The received video is digitized and stored in the memory, storage device and/or other digital storage device.

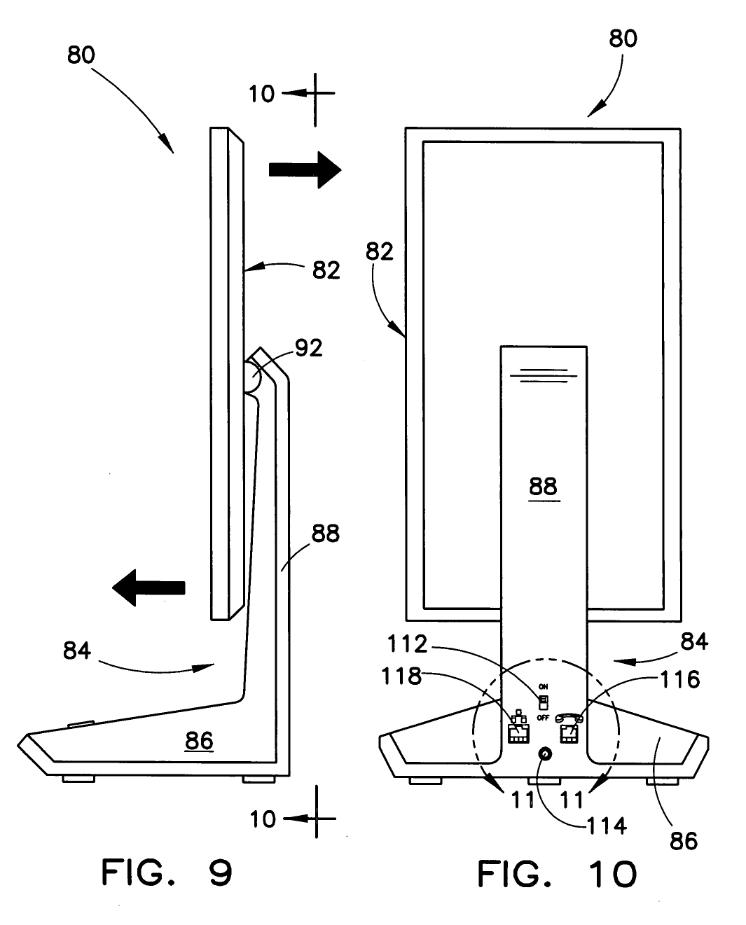

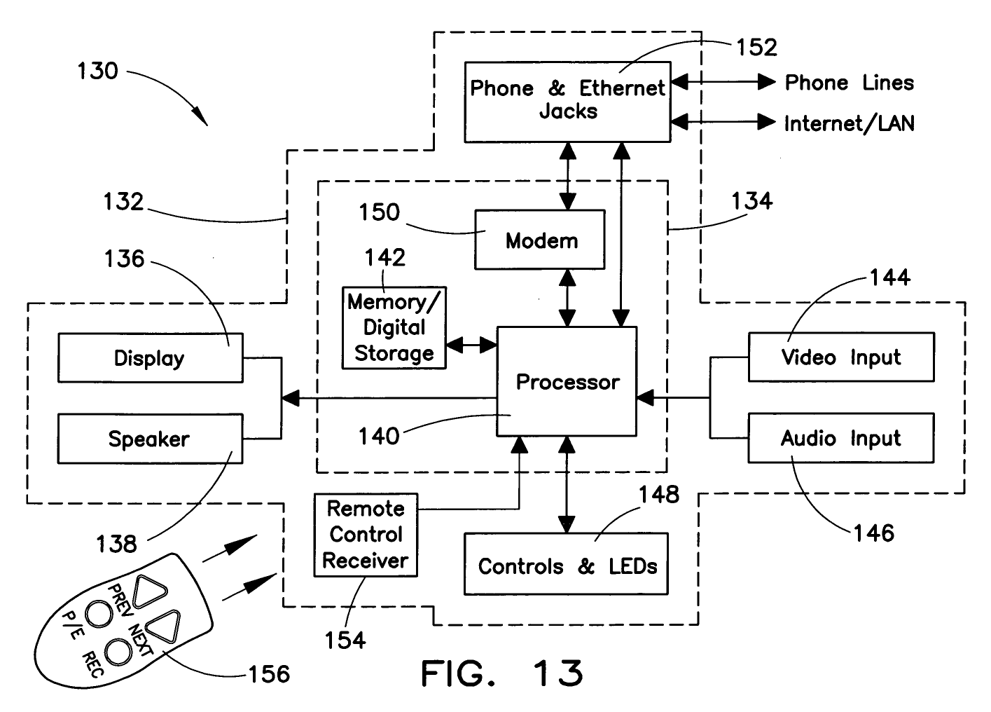

As best seen in FIG. 9, the panel 82 is attached to the arm 88 via a pivot 92. This allows the panel 82 and thus the display 90 to tilt back and forth as represented by the arrows in FIG. 9. In FIGS. 7-10, the panel 82 and thus the display 90 is situated in a portrait orientation. The pivot 92 also allows the panel 82 and thus the display 90 to rotate as represented by the arrows in FIG. 12. FIG. 12 also shown the panel 82 and thus the display 90 situated in a landscape orientation.

In order to receive audio for recording and/or storage in the memory or storage device of the present audio/video messaging device 80, the base 86 supports a microphone or other type of audio pickup or reception device 100. The microphone 100 is preferably, but not necessarily, situated behind a plurality of holes in the base 86. The microphone 100 is operable to receive audio from the user. The LED 96 is operable to indicate to the user that the microphone 100 is on and thus the recording of audio is about to occur and/or is occurring. The LED 96 is also operable to indicate that the microphone 100 is off. The received audio is digitized and stored in the memory, hard drive or other digital storage device of the audio/video message device 80. A speaker 98 is situated in the base 86 behind the plurality of holes in the top of the base 86. The speaker 98 is operable to play back the recorded audio.

Since the audio/video messaging device 80 is electronic, it must use electricity. As such, the audio/video messaging device 80 uses batteries or is connectable to a source of alternating current (A/C) electricity (e.g. a household A/C outlet) either through an appropriate power supply that resides external thereto (with a power cord) or is internal thereto. A power jack 114 is provided for receipt of a power cord. Optionally, the audio/video messaging device 80 may include battery back-up. An on/off switch 112 is provided in order to turn the audio/video messaging device 80 on and off. It is not necessary to turn the audio/video messaging device 80 on and off between uses as it goes into and remains in a low power consumption (i.e. standby mode) when not in use.

The user interface or message controls/indicators of the present audio/video messaging device 80 is situated on the base 86 and includes a Record button or key 102, a Play/Erase button or key 104, a Next or right advance button or key 106, a Previous or left advance button or key 108 and a plurality of audio/video message slot LEDs 110. The Record key 102 is operable to begin recording an audio/video message. The Play/Erase key 104 is operable to play an audio/video message and to erase an audio/video message. The LEDs 110 each represent individual message “slots” or discrete number of audio/video messages that can be recorded and/or played. It should be appreciated that while five (5) LEDs 110 are shown, and thus the audio/video messaging device 80 can accommodate five (5) audio/video messages, the number of LEDs and thus number of audio/video slots may vary as desired. Additionally, while not shown, the individual LEDs 110 representing the number of audio/video message slots may be replaced by other indicators or a single indicator as desired.

The audio/video messaging device 80 provides a discrete number of audio/video message “slots” for recording audio/video messages and which indicate whether a message slot is empty and thus ready for recording an audio/video message, whether a message slot has a recorded message, and whether a message slot that has a recorded audio/video message has been played or viewed and heard.

The Next and Previous keys 106 and 108 are operable to advance or move back and forth between each memory or audio/video message slot. In this manner, the user may cycle through the message slots in order to move to a particular audio/video message slot. A message slot may be unused or open (i.e. no message exists for or is associated with the particular message slot) and ready for recording of an audio/video message. This is represented by having the associated LED 110 off in the same manner as that described for the audio/video device 30 described above with reference to FIG. 6. A message slot may be occupied or contain or be associated with an audio/video message. The occupied message slot may contain an audio/video message that either has or has not been played. When the message slot has an audio/video message that has not been played, the associated LED 110 will be on and flashing. When the audio/video message has been played, the LED 110 will be on but not flash and be a solid color. An on LED 110 (whether flashing or solid) is of a particular color such as green such as described above with reference to FIG. 6. As the user cycles through the message slots, the associated LED 110 is highlighted (i.e. solid on) by use of a second particular color such as yellow. Selection may be for playing an audio/video message that resides at that particular message slot or may be for recording an audio/video message where no audio/video message resides at the particular message slot. It should be appreciated that other schemes may be used to indicate whether an audio/video message slot is open (empty or unoccupied) or contains an audio/video message and whether it has or has not been played.

When a highlighted message slot is occupied, pressing the Play/Erase key 104 will play the audio/video message. Preferably, but not necessarily, the display 90 will automatically turn off and the audio/video messaging device 80 will go into a standby mode after the playing of the audio/video messaging device 80 and/or within a predetermined period of time of non-use. The audio/video messaging device 80 does not have to be physically turned off between uses, as it will remain in a low power consumption state (i.e. standby mode) until the next operator activity. Holding down the Play/Erase key 104 for a predetermined amount of time (e.g. 5 seconds) will erase the audio/video message from the particular message slot. All audio/video messages will remain in memory until they are erased, even if the audio/video messaging device 80 is turned off or unplugged. After an audio/video message has been erased, the particular message slot is ready to record another audio/video message.

Recording of an audio/video message is initiated by selecting an open message slot utilizing the Next and/or Previous message slot navigation keys 106 and 108. Pressing the Record key 102 will turn on the display 90 and show a live image from the camera 94. The LED 96 indicator will flash for a predetermined period of time (e.g. 5 seconds) giving the user time to position himself/herself as appropriate. The LED 110 will turn to a solid color (e.g. green) and the camera 94 and the microphone 100 being recording an audio/video message. Preferably, but not necessarily, a predetermined amount of time (e.g. 60 seconds) is provided per audio/video message. When the predetermined amount of recording time has expired, the recording stops and the audio/video message is stored in the memory, hard drive or other digital storage media/device. Pressing the Record key 102 before the predetermined amount of record time has expired will stop recording at that point. The audio/video message will then be stored in the memory, hard drive or other digital storage media/device.

In another manner or in addition to the above, when initiating a recording, the color display 90 may show a black and white image while the LED 96 is flashing during the positioning period or instead of the flashing LED 96 to provide a more distinct indication of the positioning period. After the predetermined positioning period of time, the display 90 goes to color indicating that recording is taking place.

The audio/video messaging device 80 also includes a telephone jack 116 for connection to a telephone line. This allows the audio/video messaging device 80 to communicate via services offered through a telephone line such as is described below. Moreover, the audio/video messaging device 80 includes an Ethernet jack 118 for connection to an Ethernet port. This allows the audio/video messaging device 80 to communicate via Ethernet such as is described below. In brief, such communication involves sending and/or receiving audio/video messages to and/or from another audio/video messaging device.

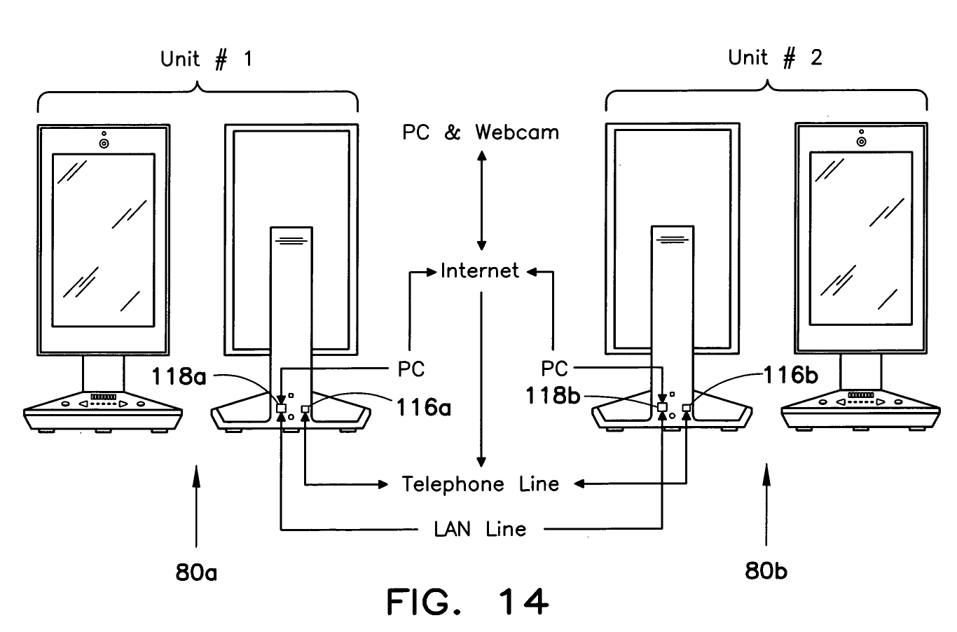

FIG. 13 depicts a simple functional block diagram of the present audio/video messaging device generally designated 130 representing the various embodiments of the audio/video messaging devices described herein and showing another feature that may be incorporated into any one of the present audio/video messaging devices. The audio/video messaging device 130 includes a housing 132 holding a processing portion 134. The processing portion 134 includes a processor 140 and memory/digital storage 142. The processor 140 receives video and audio input from video input 144 and audio input 146 respectively from the recording of an audio/video message. The memory/digital storage 142 is on communication with the processor 140 for receiving and storing the audio/video messages. A display 136 and speaker 138 are in communication with the processor 140 for displaying the video and playing the audio of the audio/video messages. Controls and LEDs 148 are in communication with the processor 140 for controlling the recording, playing, erasing, receiving and sending of audio/video messages. As such, a modem 150 or other communication device is in communication with the processor 140 for receiving and sending audio/video messages. The modem 150 is in communication with phone and Ethernet jacks 152 which are, in turn, respectively connected to a telephone line and the Internet and/or LA/V.

The audio/video messaging device 130 also includes a remote control receiver 154 that is in communication with the processor 140. The remote control receiver 154 is configured, operable and/or adapted to receive and decode signals/commands from a remote control 156 in order to control the recording, playing and erasing of audio/video messages and provide such commands to the processor 140 for execution by the audio/video messaging device. To this end, the remote control 156 includes a Record button or key, a Play/Erase (P/E) button or key, a Previous button or key, and a Next button or key whose functions are the same as those described above. While not shown, the remote control 156 may also include buttons and/or keys to provide for the receiving and/or sending of audio/video messages as described herein. Other features and/or functions may be incorporated into the remote control 156 as desired. The remote control 156 and thus the remote control receiver 154 may use infrared (IR) technology such as is known in the art, radio frequency technology such as known in the art or otherwise. Such remote control may be incorporated into any one of the various audio/video messaging devices.

The video protocol, audio protocol, and digital video storage protocol used by the present audio/video messaging device 30 are those known in the art such as webcam or digital video protocols, digital audio protocols and the like. As well custom programming may be used if desired.

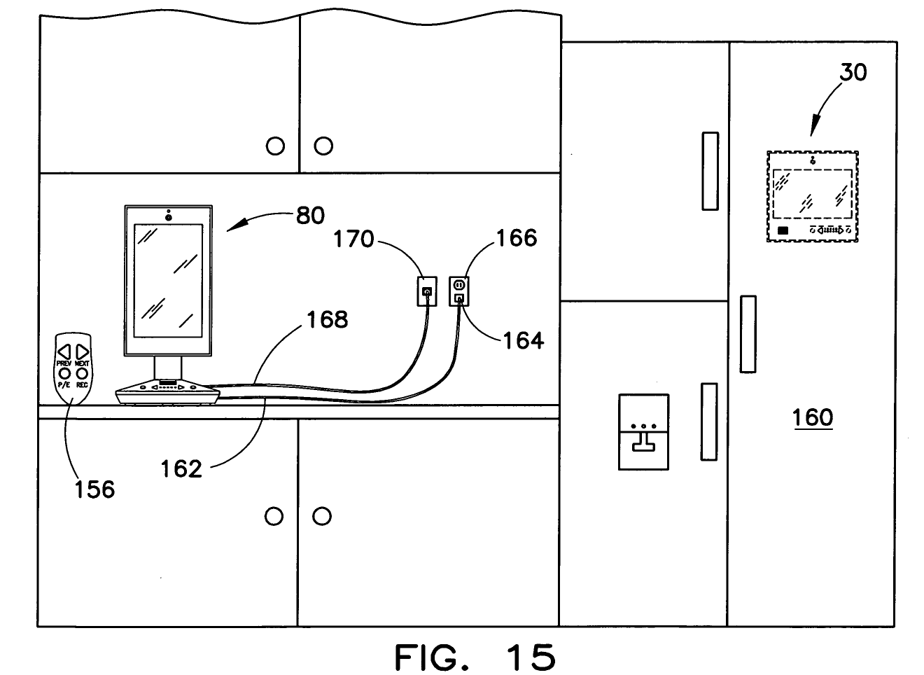

The present audio/video messaging device is also capable of transmitting and/or receiving audio/video messages from one audio/video messaging device to other audio/video messaging device. This is illustrated in FIG. 14 and reference is now made thereto. In FIG. 14 there is shown unit #1 representing any one of the present embodiments of an audio/video messaging device fashioned in accordance with the present principles (here being an audio/video messaging device 80a) and unit #2 also representing any one of the present embodiments of an audio/video messaging device fashioned in accordance with the present principles (here being an audio/video messaging device 80b). The audio/video messaging devices 80a and 80b are shown utilizing various connections or communication modes. In particular, three main connection or communication modes are achievable with the present audio/video messaging device: 1) from an audio/video messaging device to another audio/video messaging device; 2) from a PC to an audio/video messaging device; and 3) from an audio video messaging device to a PC. Connection variations may provide other connection or communication modes as shown.

One manner of communication between unit # 1 and unit #2 is via their internal modems and telephone jacks 116a and 116b. Units #1 and #2 are connected via a telephone line to the telephone jacks 116a and 116b of respective audio/video messaging devices 80a and 80b. This allows an audio/video message created on one audio/video messaging device to be sent to and received and stored by the other audio/video messaging device. As the telephone line may be used to access the Internet, audio/video messages may be sent by and/or received through the Internet via a PC. A PC may utilize a webcam to generate an audio/video message.

Another manner of communication between unit #1 and unit #2 is via an Ethernet connection, LA/V, WA/V or the like by connection with the Ethernet jacks 118a and 118b of the respective audio/video devices 80a and 80b. Again, this allows an audio/video message created on one audio/video messaging device to be sent to and received and stored by the other audio/video messaging device.

Another manner of communication between unit #1 and unit #2 is via PC connection to each audio/video messaging device via the Ethernet jacks 118a and 118b of respective audio/video messaging devices 80a and 80b. This allows an audio/video messaging device to communicate via the Internet or via another PC and webcam.

Referring lastly to FIG. 15, there is shown an audio/video messaging device 80 sitting on a counter in a kitchen, illustrating where the preset audio/video messaging may be placed. The remote control 156 is shown which may control one or both of the audio/video messaging devices. The audio/video messaging device 80 is connected to a household A/C outlet 166 via an electrical cord 162 and power source/transformer 164. The audio/video messaging device 80 is also shown in communication with a communication jack 170 via a communication line 168. The communication jack 170 may be a telephone jack or Ethernet jack.

FIG. 15 also depicts a refrigerator 169 incorporating the present audio/video messaging device 30 as representative of the ability of the present audio/video device to be incorporated into various consumer products and/or appliances. Examples of other consumer products/appliances, without being exhaustive, include microwaves, stoves, ovens, telephones, televisions, washers, dryers, toasters, coffee makers and digital picture frames. The present audio/video messaging device may also be provided in automobiles.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

What is claimed is:

1. A messaging device comprising:
a video camera for receiving video for an audio/video message;
a microphone for receiving audio for the audio/video message;
memory for storing the received audio and video for the audio/video message;
a display for playing the video of the stored audio/video message;
a speaker for playing the audio of the stored audio/video message; and
a user interface for managing recording and playing of the audio/video message.

2. The messaging device of claim 1, further comprising:
processing in communication with the video camera, microphone, memory and user interface.

3. The messaging device of claim 1, further comprising:
a communication port for receiving and sending an audio/video message.

4. The messaging device of claim 1, wherein the display, video camera, microphone, speaker, memory and user interface are supported in a panel.

5. The messaging device of claim 4, wherein the panel is pivotally supported on a stand.

6. The messaging device of claim 1, wherein the memory is one of flash memory and a hard drive.

7. The messaging device of claim 1, wherein the user interface includes a remote control.

8. The messaging device of claim 1, wherein the user interface includes a record button operable to initiate recording of the audio/video message, a play button operable to play a stored audio/video message, and an indicator operable to display whether an audio/video message has been recorded.

9. A messaging device comprising:
a processor;
a video camera in communication with the processor and operable to receive video for an audio/video message;
a microphone in communication with the processor and operable to receive audio for an audio/video message;
digital storage in communication with the processor and operable to store the video received from the video camera and the audio from the microphone for an audio/video message;
a display in communication with the processor and operable to play the video of a stored audio/video message;
a speaker in communication with the processor and operable to play the audio of a stored audio/video message;
controls for managing recording and playing of an audio/video message;
wherein the messaging device is operable to allow receipt and playback of up to a predetermined number of audio/video messages.

10. The messaging device of claim 9, wherein an audio/video message is recordable up to a predetermined length of time.

11. The messaging device of claim 9, further comprising a predetermined number of audio/video message indicators corresponding to the predetermined number of audio/video messages, each one of the audio/video message indicators operable to indicate whether an audio/video message is present and whether it has been played.

12. The messaging device of claim 11, wherein the controls further provide for erasing a recorded audio/video message.

13. The messaging device of claim 12, wherein the controls include a record button operable to initiate recording of the audio/video message, a play button operable to play a stored audio/video message, and an indicator operable to display whether an audio/video message has been recorded.

14. The messaging device of claim 13, wherein the controls further include a navigation button operable to select a particular recorded audio/video message.

15. The messaging device of claim 13, wherein the controls includes a remote control having a record button operable to initiate recording of the audio/video message, a play button operable to play a stored audio/video message, an indicator operable to display whether an audio/video message has been recorded, and a navigation button operable to select a particular recorded audio/video message.

16. The messaging device of claim 9, further comprising a communication port for receiving an audio/video message and for sending an audio/video message.

17. A messaging device comprising:
an audio/video recorder operable to receive an audio/video message;
a plurality of audio/video message slots each one of which is operable to store a received audio/video message;
an audio/video player operable to play a stored audio/video message; and
a user interface operable to select any one of the plurality of audio/video message slots in order to allow recording, playback and erasure of an audio/video message associated with the selected one of the plurality of audio/video message slots.

18. The messaging device of claim 17, further comprising a plurality of indicators corresponding in number to the plurality of audio/video message slots, each one of the plurality of indicators associated with one of the plurality of audio/video indicators and operable to visually show whether an audio/video message is stored in the associated audio/video message slot and whether the associated audio/video message has been viewed.

19. The messaging device of claim 18, wherein each one of the plurality of indicators comprises an LED.

20. The messaging device of claim 17, wherein the user interface includes a record button operable to initiate recording of an audio/video message, a play button operable to play a stored audio/video message, and an erase button operable to delete a recorded audio/video message.
